(19) United States
(12) Patent Application Publication
(10) Pub. No.: US 2011/0182257 A1
(43) Pub. Date: Jul. 28, 2011

(54) WHITE SPACE SPECTRUM COMMMUNCIATION DEVICE WITH MULTIPLEXING CAPABILTIES

(75) Inventors: Vijayalakshmi R. Raveendran, San Diego, CA (US); Ahmed K. Sadek, San Diego, CA (US)

(73) Assignee: QUALCOMM Incorporated, San Diego, CA (US)

(21) Appl. No.: 13/012,911

(22) Filed: Jan. 25, 2011

Related U.S. Application Data
(60) Provisional application No. 61/298,498, filed on Jan. 26, 2010.
(60) Provisional application No. 61/309,566, filed on Mar. 2, 2010.

(51) Int. Cl. H04W 4/00

(52) U.S. Cl. 370/329

(57) ABSTRACT

In one example, a method includes receiving a plurality of input signals at a multiplexer of a white space device, and generating, via the multiplexer, a multiplexed output signal that includes at least two of the plurality of input signals. The method also includes sensing whether a white space frequency is available for unlicensed use, and communicating the multiplexed output signal over the white space frequency via a transmitter of the white space device when the white space frequency is available for unlicensed use.

This application claims the benefit of each of the following U.S. Provisional Patent applications:

U.S. Provisional Application 61/298,498 filed on Jan. 26, 2010 and bearing attorney docket number 100818P1, and

U.S. Provisional Application 61/309,566 filed on Mar. 2, 2010 and bearing attorney docket number 100818P2,

the entire contents each of which are incorporated herein by reference.

### TECHNICAL FIELD

This disclosure relates to wireless communication.

### BACKGROUND

Several white space frequencies have been allocated by the Federal Communication Commission (FCC) for unlicensed use by the public under certain conditions. White space frequencies generally refer to frequencies of electromagnetic radiation that are allocated by the FCC (or other government agencies) for such public unlicensed use. In order for unlicensed devices to utilize white space frequencies, the government may impose one or more conditions, such as the requirement that the unlicensed devices to periodically search one or more frequencies for licensed users, e.g., to avoid conflicts. Unlicensed devices may use white space frequencies if licensed users are not present, but may be required to refrain from use of such frequencies when licensed users are present.

### SUMMARY

In general, this disclosure describes a white space spectrum communication device that receives input signals from multiple input devices, creates a white space broadcast signal based on the input signals, and transmits the white space broadcast signal to another device over a white space frequency. The white space spectrum communication device may multiplex the input signals from the multiple devices to produce the white space broadcast signal. The described white space device may comprise a fixed or mobile electronics device used in any of a variety of settings, such as home, office, or security settings, although other uses are envisioned.

In one example, this disclosure describes a method that comprises receiving a plurality of input signals at a multiplexer of a white space device, and generating, via the multiplexer, a multiplexed output signal that includes at least two of the plurality of input signals. The method also comprises sensing whether a white space frequency is available for unlicensed use, and communicating the multiplexed output signal over the white space frequency via a transmitter of the white space device when the white space frequency is available for unlicensed use.

In another example, this disclosure describes an apparatus comprising a multiplexer that receives a plurality of input signals and generates a multiplexed output signal that includes at least two of the plurality of input signals, and a white space transmitter that senses whether a white space frequency is available for unlicensed use, and communicates the multiplexed output signal over the white space frequency when the white space frequency is available for unlicensed use.

In another example, this disclosure describes device comprising means for receiving a plurality of input signals in a white space device, means for generating a multiplexed output signal that includes at least two of the plurality of input signals, means for sensing whether a white space frequency is available for unlicensed use, and means for communicating the multiplexed output signal over the white space frequency when the white space frequency is available for unlicensed use.

The techniques described in this disclosure may be implemented in a variety of ways. In some cases, the techniques may be implemented at least in partially in hardware, possibly using aspects of software or firmware in combination with the hardware. If implemented partially in software or firmware, the software or firmware may be executed in one or more hardware processors, such as a microprocessor, application specific integrated circuit (ASIC), field programmable gate array (FPGA), or digital signal processor (DSP). The software that executes the techniques may be initially stored in a computer-readable medium, such as a memory or another tangible storage medium, and loaded and executed in the one or more processors.

Accordingly, this disclosure also contemplates a computer-readable storage medium comprising instructions that upon execution cause one or more processor to upon receiving a plurality of input signals at a multiplexer of a white space device, generate, via the multiplexer, a multiplexed output signal that includes at least two of the plurality of input signals, sense whether a white space frequency is available for unlicensed use, and communicate the multiplexed output signal over the white space frequency via a transmitter of the white space device when the white space frequency is available for unlicensed use.

The details of one or more aspects are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating a white space device within a system consistent with this disclosure.

FIG. 2 is a block diagram illustrating a white space device that includes other types of transmitters in addition to a white space transmitter.

FIG. 3 is an exemplary block diagram of a white space (WS) transmitter consistent with this disclosure.

FIGS. 4-6 are flow diagrams illustrating techniques consistent with this disclosure.

FIG. 7 is another block diagram illustrating a white space device within a system consistent with this disclosure.

FIG. 8 is a flow diagram illustrating a technique that may be performed by the white space device shown in FIG. 7.

### DETAILED DESCRIPTION

This disclosure describe a white space device that receives input signals from multiple devices, creates a white space broadcast signal based on the input signals, and transmits the white space broadcast signal to another device over a white space frequency. In this disclosure, the phrase “white space frequency” generally refers to one or more frequency bands of electromagnetic radiation allocated by a government for unlicensed use by the public. In some examples, the white space frequency may include one or more unused channels of a television broadcast spectrum. The described white space device may comprise an electronics device used in the home, office, or in security settings, although other uses are envisioned.

Many high definition televisions (HDTVs) include a receiver and a tuner, which may comprise a combined receiver and tuner for receiving and tuning to a channel of a broadcast. The tuner may comprise an Advanced Television Systems Committee (ATSC) tuner and/or a National Television Systems Committee (NTSC) tuner. In some cases, HDTV's are mandated by the Federal Communication Commission (FCC) of the United States to include such tuners. The ATSC tuner, for example, can receive multiplexed signals and tune to different channels (or programs) of choice. Such tuners may also be designed to receive broadcasts at white space frequencies, which again, may include one or more TV band frequencies. A wide variety of other types of devices could likewise be equipped with white space receivers and tuners.

Several white space frequencies have been allocated by the FCC for unlicensed use by the public. Again, white space frequencies generally refer to any such frequencies allocated by the FCC (or other government agencies) for such public unlicensed use. The government may require unlicensed devices to periodically search whitespace frequencies (such as TV band frequencies) for licensed users, and refrain from use of the white space frequencies when licensed users are present. In some cases, the searching of whitespace frequencies searches for any users, which may be presumed to be licensed users, if present.

White space devices generally refer to any devices with a wireless transmitter that communicates over white space frequencies. These white space devices generally operate in a cognitive manner in which the devices first scan a prescribed spectrum to detect TV band signals from licensed primary users (or any users) and then select unused channels in order to avoid interference with the licensed signals.

This disclosure concerns a white space device that has multiple input ports for receiving multiple inputs from different devices. The white space device also includes a multiplexer that selects (and typically combines) some or all of the different inputs to the device to create a multiplexed broadcast signal. The white space device may then broadcast its multiplexed broadcast signal to other devices, which may be typically located within a local area of the white space device, such as a home or office. The other devices may be equipped with a tuner that allows such devices to tune to specific portions of the multiplexed broadcast signal, and deliver content from one of the input devices

The techniques of this disclosure may be used to combine and broadcast multimedia data, although other types of data could also be combined and broadcasted in the manner described herein. In this disclosure, multimedia data refers to video data, image data, audio data, text, graphics, sensory signals and any combinations thereof.

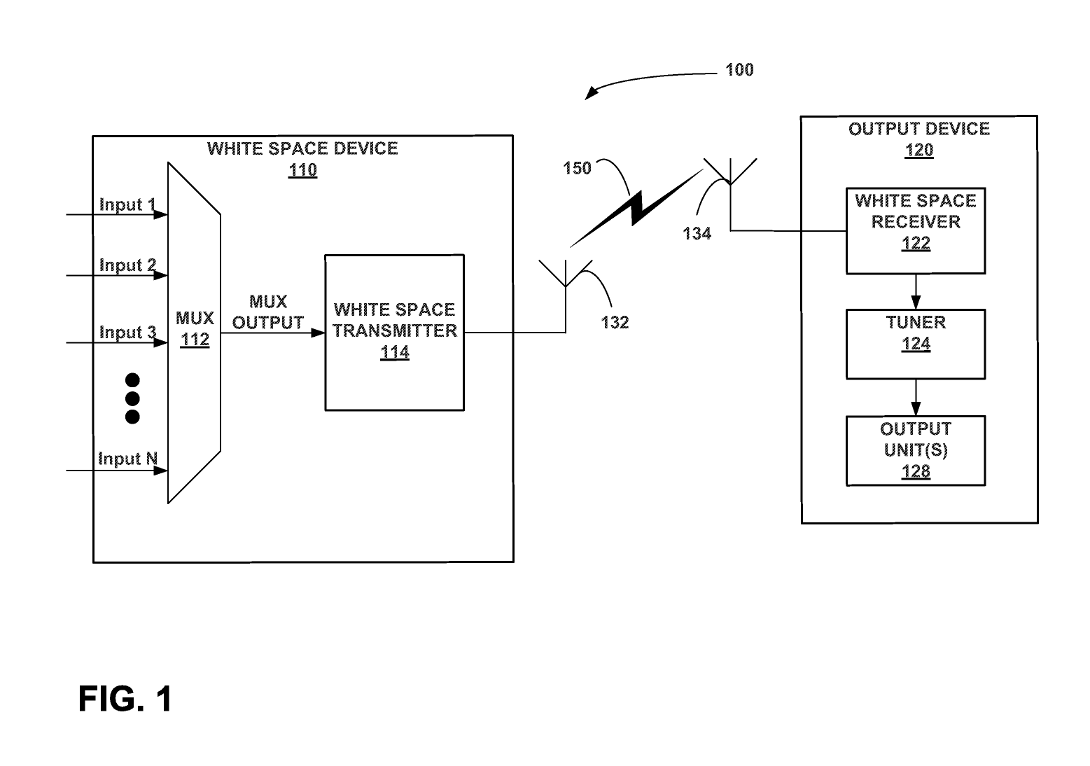

FIG. 1 is a block diagram illustrating a white space device 110 within a system 100 consistent with this disclosure. White space device 110 is capable of receiving multiple input signals from different sources. For example, white space device 110 may receive input 1, input 2, input 3, up to any number of inputs N, as illustrated in FIG. 1. Each input may have an associated port in white space device 110. The ports can deliver the input signals to multiplexer (MUX) 112 of white space device. For example, the different inputs to white space device 110 may comprise multimedia signals, such as video signals, audio signals, or audio-video signals, although any type of information or data could be input to white space device 110. More generally, the inputs could come from any type of device and could include any type of data. Exemplary input devices that could provide the input signals to white space device 110 include portable multimedia devices, media players such as digital video disk (DVD) players, BluRay players, and game consoles. Other input devices that could provide the input signals to white space device 110 include set top boxs (STBs), security cameras, media services, portable media players, DVD or Blu-Ray players, game consoles such as the PS3, Xbox or Wii, camcorders, distributed control systems (DSCs), digital cameras, audio devices, media servers, personal computers (PCs), or any other type of computer, and the like.

MUX 112 receives a plurality of input signals and generates a multiplexed output signal (“MUX output”) that includes at least two of the plurality of input signals. The multiplexed output may be frequency division multiplexed across two or more channels of a white space frequency, although time division multiplexing may be used alternatively or in addition to the frequency division multiplexing. However, if time divisional multiplexing is added or used, then a de-multiplexer may be required at the output device that receives the signal. With frequency division multiplexing, the output device may simply require a TV tuner to receive a given signal multiplexed on a particular channel of the white space frequency.

Typically, all of the input signals may be included in the multiplexed output signal, although fewer inputs could be selected for output, if desired. White space transmitter 114 receives the multiplexed output signal and generates a white space broadcast signal based on the multiplexed output signal. In doing so, white space transmitter 114 may sense whether a white space frequency is available for unlicensed use, and communicate the multiplexed output signal over the white space frequency when the white space frequency is available for unlicensed use. Such white space sensing may be needed as a prerequisite for unlicensed use of the white space frequency.

In some examples, sensing whether a white space frequency is available for use may include the scanning of one or more frequencies to determine whether other uses (e.g. licensed users) are already using the white space frequency. However, other techniques for sensing whether a white space frequency is available may also be used. For example, geo-location sensing could be used to determine the geo-location of the device, and based on the geo-location of the device, available white space may be determined. In general, a white space channel list may be determined via spectrum sensing, geo-location sensing or both. The device may monitor white space channel available (again by checking for spectrum use or by determining geo-location and using geo-location to determine white space channel availability) so as to protect primary licensed users from interference from white space device 110.

White space transmitter 114 may include an antenna 132 that broadcasts a white space broadcast signal 150 to a corresponding antenna 134 of white space receiver 122 at output device 120. Any number of output devices could receive broadcast signal 150, although only one output device 120 is shown in FIG. 1 for ease of illustration. Output device 120 generally receives broadcast signal 150, tunes to a particular channel within the white space frequency and delivers content in that channel to a user. The particular channel may include the input from one of input devices that deliver inputs to MUX 112 of white space device 110.

At output device 120, white space receiver 122 receives white space broadcast signal 150 via antenna 134 and delivers the signal to tuner 124. In some cases, white space receiver 122 and tuner 124 may collectively comprise a television tuner, or the like. Tuner 124 may tune to a particular frequency of broadcast signal 150, which may correspond to one of the original input signals received by white space device 110 and multiplexed into the multiplexed output signal of the broadcast. A user may be able to select channels via tuner 124 in order to tune to one of the input signals included in white space broadcast signal 150. Tuner 124 may then deliver its tuned signal to one or more output units 128 for presentation to a user. Output units 128, for example, may comprise one or more display screens, audio speakers, or any output units capable of delivering content or information to a user at output device 120. Output device 120, in some examples may comprise a high definition television (HDTV) that includes an

ATSC tuner (as mandated by FCC). In this example, receiver 122 and tuner 124 may collectively comprise the ATSC tuner of an HDTV. Once the broadcast signal 150 is received at output device 120 by white space receiver 122 and tuner 124 (again which may comprise an ATSC tuner) can be tuned to the channel (or program) of choice. The channel may be a user-selected channel or a channel selected based on as some pre-determined criterion, and may include content from one of the input devices that provide the initial content to white space device 110.

As mentioned, broadcast signal 150 may comprise a broadcast of the multiplexed output signal, and therefore, broadcast signal typically includes two or more input signals originally input to white space device 110. In general, input signals to white space device 110 are multiplexed into different channels by MUX 112 and broadcast by white space transmitter. In particular, input signals to white space device 110 may be frequency multiplexed into different frequency channels within a white space spectrum by MUX 112. Time division multiplexing may also be used, but this may require a de-multiplexer at output device 120. Output device 120 receives broadcast signal 150, tunes to a particular channel within the white space spectrum and delivers content in that channel to a user. In some cases, a sensing unit (not shown in FIG. 1) may perform sensing of white space channels, and the sensor unit may provide information back to MUX 112 regarding the available channels in order to aid in the multiplexing across those available white space channels.

As non-limiting examples, broadcast signal 150 may be generated by white space transmitter 114 to conform to a digital broadcast format, such as an Advanced Television Systems Committee (ATSC) format, a Digital Video Broadcasting (DVB) format, a Terrestrial Digital Multimedia Broadcasting (T-DMB) format, an Integrated Services Digital Broadcasting Terrestrial (ISDB-T) format, or a Moving Picture Experts Group Transport Stream (MPEG-TS) format, provided by International Standard ISO/IEC 13818-1, to name only a few. ATSC standards are a set of standards developed by the Advanced Television Systems Committee for digital television transmission. DVB standards are a suite of internationally accepted, open standards for digital television, and are published by a Joint Technical Committee (JTC) of European Telecommunications Standards Institute (ETSI), European Committee for Electrotechnical Standardization (CENELEC), and European Broadcasting Union (EBU). DMB is a digital radio transmission technology for sending multimedia data to mobile devices. ISDB is a Japanese standard for digital television and digital radio. Other wireless standards might also be used for broadcast signal 150, including mobile broadcast standards such as Advanced Television Systems Committee—Mobile/Handheld (ATSC M/H), FO EV, Digital Multimedia Broadcast-handheld (DVB-H), Digital Multimedia Broadcast-satellite services to handheld DVB-SH, and next generation mobile broadcast standards. In addition, NTSC standards and next generation National Television System Committee NTSC standards might also be used in some examples. Also, standards such as third generation (3G) standards, third-generation multimedia broadcast multicast service (3G MBMS), Broadcast and Multicast Services (BCMCS), long term evolution broadcast (LTE(broadcast)), or numerous other standards may be used as well.

A digital broadcast format may be a broadcast format in which no specific or particular destination is provided in or specified by the transmitted data. For example, a digital broadcast format may comprise a format in which the header of a broadcasted data packet or unit does not include any destination address. In any case, broadcast signal 150 includes two or more of the original input signals that are combined by MUX 112 into the multiplexed output signal. Accordingly, broadcast signal 150 may comprise a mechanism for simultaneously delivering multiple forms of multimedia content or other information from white space device 110 to output device 120. Again, any number of output devices could receive broadcast signal 150, although only one output device 120 is shown in FIG. 1 for ease of illustration.

As mentioned, white space transmitter 114 may include sensing or geo-location capabilities so as to provide a cognitive approach to the transmission of any data. In particular, white space transmitter 114 may sense whether the white space frequency (which may include one or more TV band frequencies or channels) is available for unlicensed use. Such sensing by white space transmitter 114 may occur at periodic intervals sufficient to comply with governmental requirements mandated by the government (e.g., the FCC) in order to proceed with unlicensed use of white space frequencies.

Furthermore, when white space transmitter 114 performs sensing operations to determine whether the white space frequency is available for unlicensed use, white space transmitter 114 may blank, i.e., temporarily stop, its transmissions during the sensing operations. In this way, outgoing transmissions from white space transmitter 114 will not interfere with or otherwise impact the sensing performed by white space transmitter 114.

In communicating the multiplexed output signal over the white space frequency, white space transmitter may broadcast the output signal in a digital broadcast format over the white space frequency. The digital broadcast format may conform to any of the digital broadcast formats mentioned above, or possibly another format. Again, the white space frequency may comprise one or more frequency bands allocated by a government for unlicensed use, and may include one or more frequency bands allocated for television by the government for licensed users and allocated for unlicensed use in the absence of use by the licensed users.

As mentioned above, the different inputs to MUX 112 may be delivered from different input devices. However, it is also contemplated that some or all of the inputs to MUX 112 could come from one or input units that exist within white space device 110. For example, white space device 110 could include television tuners (not shown) for receiving broadcast television data and the inputs to MUX 112 could be the outputs of the respective tuners. In this example, broadcast signal 150 may comprise a re-broadcast of data received by the respective tuners (not shown) within white space device 110. Also, other types of data could be stored, received or generated by various units within white space device 110, and such internal units could define one or more of the inputs to MUX 112. Accordingly, although many examples below are described in the context of input devices that provide inputs to MUX 112 of white space device 110, the inputs to MUX 112 may also comprise data that is stored, received or generated by other units (not shown) within white space device 110. For example, white space device 110, in other examples, may comprise a media device that itself stores or generates multimedia content that can be multiplexed with other content and broadcasted as described herein.

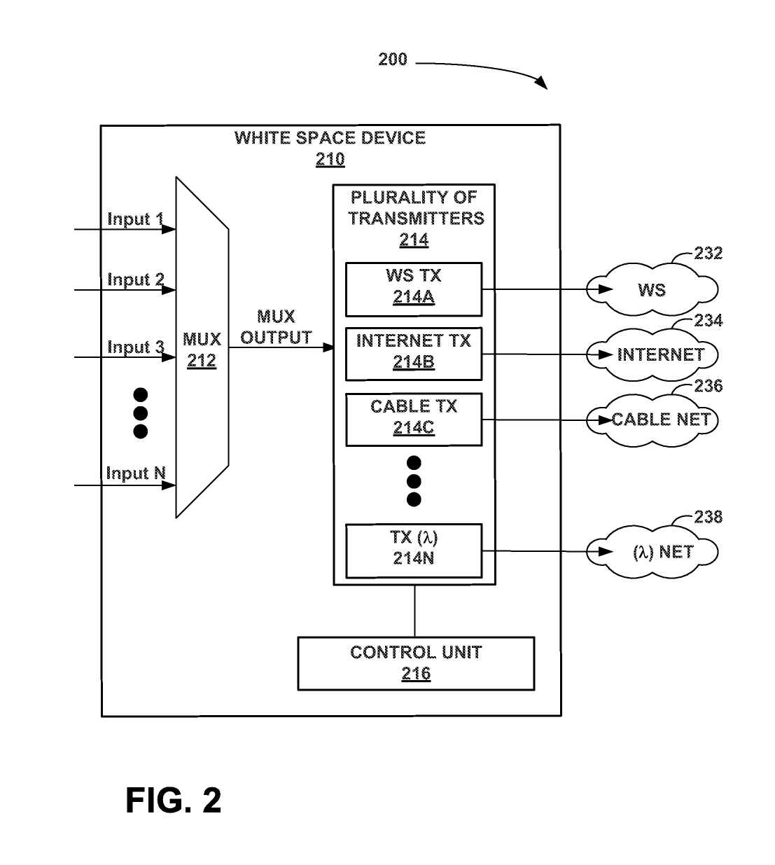

FIG. 2 is another block diagram illustrating a white space device 210 within a system 200 consistent with this disclosure. White space device 210 in FIG. 2 may be very similar to white space device 110 of FIG. 1, in many respects. In particular, white space device 210 may receive input 1, input 2, input 3, up to any number of inputs N, and each input may have an associated port in white space device 210. The ports can deliver the input signals to multiplexer (MUX) 212 of white space device 212. The different inputs to white space device 210 may comprise multimedia signals, such as video signals, audio signals, or audio-video signals, although any type of information or data could be input to white space device 210. Different input devices may be communicatively coupled to white space device 210 (e.g., with a physical or wired connection) in order to provide the inputs to MUX 212. However, as mentioned above, it is also possible that one or more of the inputs to MUX 212 may comprise data that is stored, received or generated by other units (not shown) within white space device 210.

MUX 212 receives a plurality of input signals and generates a multiplexed output signal (“MUX output”) that includes at least two of the plurality of input signals. Typically, all of the input signals would be included in the multiplexed output signal, although fewer inputs could be selected for output, if desired. In some cases, inputs may be selectable by a user so that inputs are combined by MUX 212 on a selective basis, controllable or configurable by the user of white space device 210. MUX 212 may apply frequency division multiplexing to create a multiplexed signal that can be broadcast over different channels of white space, but may alternatively or additional perform time division multiplexing to combine multiple signals within a given channel.

Like white space device 110 of FIG. 1, white space device 210 in FIG. 2 includes a white space transmitter “WS TX” 214A. However, unlike white space device 110 of FIG. 1, white space device 210 includes a plurality of transmitters 214 and not only the white space transmitter. The plurality of transmitters 214 may include, but are not limited to WS TX 214A that communicates over white space 232, and an internet transmitter “internet TX” 214B that communicates data over the Internet 234, such as via the transmission control protocol/internet protocol (TCP/IP) or a similar packet-based communication. Internet TX 214B may be wireless, wired, fiber optic, or the like. Internet 234 may include fiber optic cables, wires, routers, switches and the like for communicating packets to a destination.

The plurality of transmitters 214 of white space device 210 may also includes a cable transmitter “cable TX” 214C, which may communicate data over a cable network “cable net” 236. Cable net 236 may comprise any local or wide area cable distribution network, and may support communications modulated according to Quadrature Amplitude Modulation (QAM) used in such cable networks. The data communicated over cable net 236 may be modulated analog signals that carry digital data. Cable TX 214C may support QAM coding and modulation techniques in order to distribute information over cable net 236. As one example, cable net 236 may comprise a home network for cable distribution to different televisions within a home. Cable TX 214C may communicate data via a multimedia over Coax Alliance (MoCA®) standard, which is a universal standard for home entertainment networking The MoCA® standard generally refers to MoCA® version 1.0, MoCA® version 2.0 or any further releases of the MoCA® standard.

More generally, the plurality of transmitters 214 of white space device 210 may include any type of transmitter and any number of transmitters. TX (N) 214N may generally refer to any type of transmitter that communicates data over any given type of network, which may comprise a wireless network, a wired network, a fiber optic network, or generally any network of devices capable of communicating information. A generic network is labeled “λ Net” 238 in FIG. 2 for demonstrative purposes. Control unit 216 may coordinate the plurality of transmitters 214 and determine which transmitter is used. In many cases, two or more transmitters may be used simultaneously to provide data redundancy or higher data throughput.

In some examples, the different transmitters within the plurality of transmitters 214 may be used in concert to communicate different portions of the MUX output from MUX 212. As one example, WS TX 214A may be used to send part of the MUX output, while another transmitter (say cable TX 214C) may be used to send another part of the MUX output. In this example, a technique performed by white space device 210 may include communicating a first portion of the multiplexed output signal via a first transmitter, and communicating a second portion of the multiplexed output signal via a second transmitter.

In other examples, the different transmitters within the plurality of transmitters 214 may be used to redundantly communicate the MUX output from MUX 212. In these examples, WS TX 214A may be used to broadcast the MUX output over white space 232, and another transmitter (say cable TX 214C) may be used to send the MUX output over another network (e.g., cable net 236). The multiple transmitters may provide for redundant communications, and may provide alternative mechanisms for communicating data to output devices via different types of networks. Thus, two or more different transmitters of the plurality of transmitters 214 may communicate the multiplexed output signal.

Referring again to FIG. 1, another aspect of this disclosure may involve the use of white space frequencies in a forward link, while allowing output device 120 to communicate over a reverse link to one or more of the input devices (not shown) that provide the input to while space device 110. Accordingly, the multiplexed output signal may be communicated over the white space frequency using a forward link, and reverse-link control signals may be communicated from output device 120 over the white space frequency to at least one of the input devices that provide inputs to MUX 112 of while space device 110.

If forward and reverse link communications are supported, the communicated signals may be time division duplexed, wherein the duty cycle of the forward link is approximately 99 percent and the duty cycle of the reverse link is approximately 1 percent. Other duty cycles could also be used. As forward-link duty cycle increases, it is usually expected that video performance increases as well. However, a relatively shorter duty cycle for the reverse link can put constraints on the reverse link signaling performance. Thus, various examples may use any duty cycle configuration that is appropriate for the particular media content and control signal requirements. In some examples, the duty cycle configuration may adaptively change during operation to improve performance as needs vary. Again, the reverse link communications may occur from output device 120 to one or more of the input devices (not shown) that provide the input to while space device 110.

White space device 110 may be communicatively coupled to its various inputs, or in some cases, could be integrated within a user device (e.g., a device associated with one or more of the inputs). In any case, white space device 110 may deliver information (e.g., audiovisual content) to output device 120 (e.g., a HDTV device) over TV white space. TV white space generally refers to specific frequency bands of white space that are licensed for television broadcasts, but which may be unused at various times or in various locations. When unused by licensed television broadcasters, TV white space may be very useful for use by unlicensed users via devices described in this disclosure.

In some cases, the multiplexing performed by MUX 212 occurs in real time, in which case, the inputs may be combined in the multiplex signal that is transmitted immediately by white space transmitter 114. Furthermore, transformation of the input signals to a digital television (DTV) format may occur, such as via multiplexer 112 or white space transmitter 114. Thus, in some cases, one or more input devices may transmit data to MUX 112 in a DTV format, while in other cases, input devices may transmit data to MUX 112 in a native format (e.g., different from a DTV format), in which case, MUX 112 or white space transmitter 114 may perform conversion of the data to a DTV format. As mentioned, input ports may be associated with the inputs to MUX 112, which may be wired interface ports. In other examples, however, the inputs to MUX 112 could be wireless inputs received over an air interface, or possibly inputs from units (not shown) within white space device 110.

The white space broadcast signal 150 may comprise a signal transmitted over multiple white space channels simultaneously. Frequency domain multiplexing may be used by white space transmitter 114 to transmit multiple white space channels simultaneously, although other types of multiplexing (such as time division multiplexing) may also be used. With frequency division multiplexing, the receiving device (e.g., output device 120) may simply require a tuner to tune to a frequency associated with one of the multiplexed inputs. If time division multiplexing is used, the receiving device (e.g., output device 120) may require an additional de-multiplexer to obtain the desired input signal from a time division multiplexed signal. In some cases, both time division multiplexing and frequency division multiplexing may be used by MUX 112 to create the broadcast signal having multiplexed inputs. In some cases, QAM (16QAM or 256QAM) may also be used to increase throughput, possibly in a specific white space channel. In system 200 of FIG. 2, for example, cable TX 214C may support QAM communications over cable network 236.

In addition to the features discussed above, various other features may be used to increase functionality. For example, some examples may include a plurality of output devices (only one output device 120 is shown in FIG. 1). The multiple output devices, for example, may comprise different televisions within a home or office. In this case, white space transmitter 112 may communicate white space broadcast signal 150 that includes a plurality of different programs to a plurality of different televisions at the same time. This example may allow users to view different programs in different rooms of a house or to set up a bank of televisions in a single room to view different programs simultaneously. In such examples, the inputs to MUX 112 may comprise digital tuners. Also, a set top box (STB) might provide several of the inputs to MUX, and in some cases, white space device 110, itself, may include several tuners that provide the inputs to MUX 112.

Many modern homes are designed to include television cables installed between and among different rooms. Referring again to FIG. 2, in such scenarios, white space device 210 may be used as a cable hub to distribute content over cable network 236 to a plurality of televisions of a given home, e.g., using QAM. Also, other networks may also be used for content distribution, such as Internet 234, or another network (X Net) 238, which may comprise any Local Area Network (LAN), a wireless LAN, an Ethernet LAN, or any network supporting streaming media. The distributed content can then be received and delivered to end users by any network-compatible device.

Again, as mentioned above, reverse link control signals may be sent back to individual input devices associated with the inputs to MUX 112. For example, reverse link control signals may be sent directly from a Human Interface Device (HID), such as a remote control, a mouse, a joystick, or another user input device. The reverse link control signals may be sent to a respective input device (such as an STB) that provides one or more inputs to MUX 112. The reverse link control signals may be sent to the input device without traversing the same path as the forward link signals associated with white space broadcast signal 150. This type of configuration may be convenient when the HID includes a Radio Frequency (RF) controller, such as a UHF remote control, that does not need a line-of-sight connection to operate. Line-of-sight controllers, such as infrared remote control devices, may be less desirable for such a configuration when the HID is in a different room than is the respective multimedia device.

In still other examples, reverse-link control signals may be received by output device 120 and communicated back through white space device 110 to a corresponding input device. Televisions, for example, could be modified to provide full decoding and full demodulation in order to receive, and pass on, reverse link control signals. As mentioned above, in some examples, white space broadcast signal 150 is a Time Division Duplex (TDD) signal where the duty cycle of the forward link is about 99 percent, whereas the duty cycle of the reverse link is about 1 percent. Other duty cycles could also be defined and used to support forward link signals for the white space broadcast signal 150 and reverse link signals for control of input devices.

In still other examples, techniques may be used to add security between input devices and white space device 110, or to provide security in the white space broadcast signal 150 from white space device 110 to output device 120. Any known or future-developed security protocol may be used to add such security to air interface links. For instance, security encoding may be added by an input device before the input signal is communicated to white space device 110 as input to MUX 112. In this case, either MUX 112 or white space transmitter 114 may remove the security coding. In another example, output device 120 (such as tuner 124) may be modified to handle security protocols, in which case, the entire forward link associated with inputs to white space device 110 and white space broadcast signal 150 from white space device 110 may be secure according to the security protocols used.

In one specific example, white space device 110 may form part of a security system used to monitor several security cameras. In this example, the different inputs to

MUX 112 may comprise camera inputs, which are combined by MUX 112 and transmitted over the white space frequency via white space transmitter 114. Accordingly, in this example, output device 120 may comprise a security camera controller that allows a user to monitor several security cameras. Output device 120 may also use reverse link signals, in this example, to control the security cameras that communicate inputs to MUX 112. A user of such a system may be able to view the images from several cameras on output units 128, which may comprise one or more televisions or computer monitors.

In still other examples, white space device 210 may be used as a middle hop to a television receiver. For the examples that add security to the air interface links, white space transmitter 214A of white space device 210 may be configured to use an air interface different from ATSC, and then cable transmitter 214C may use QAM for communication of data. White space device 210 may be capable of transmitting the information using different air-interfaces and can select among the different interfaces for particular uses. For example, the white space transmitter 214A may use ATSC to directly send information to a TV receiver via white space 232, but may also use a secondary air-interface that enables more security features. White space device 210 may also support a feedback channel back to white space transmitter 214A (which may also include a receiver in this example). In this example, white space transmitter 214A may be more adept in dealing with interference scenarios and can be equipped with more sophisticated interference cancellation schemes that conventional TV receivers may not include.

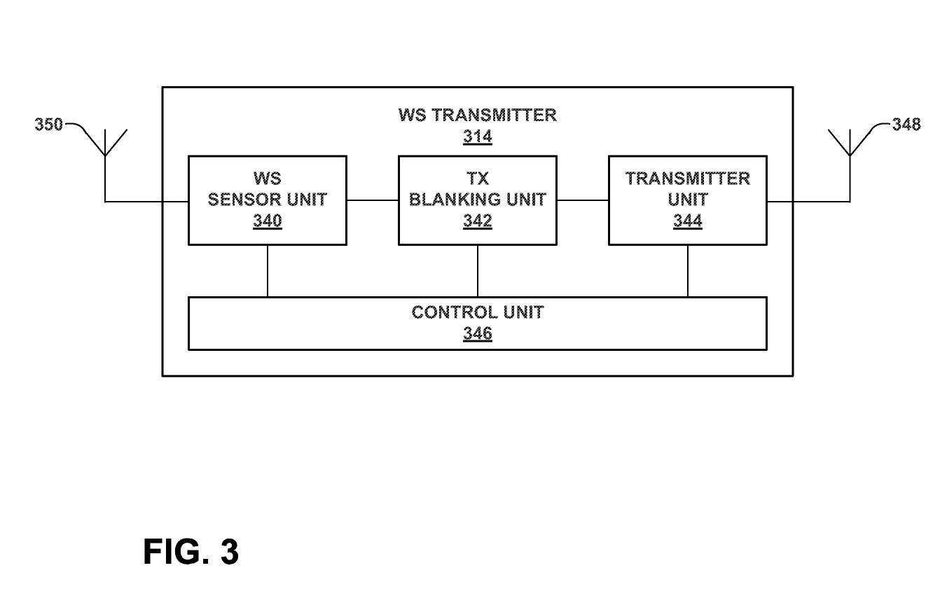

FIG. 3 is an exemplary block diagram of a white space (WS) transmitter 314, which may correspond to white space transmitter 114 of FIG. 1, white space transmitter 214A of FIG. 2, or another white space transmitter consistent with this disclosure. As shown in FIG. 3, white space transmitter 314 includes a transmitter unit 344, a white space (WS) sensor unit 340, a transmitter (TX) blanking unit 342 and a control unit 346. Transmitter unit 344 may include an antenna 348 and WS sensor unit 340 may include a separate antenna 350, although antennas 348 and 350 could also comprise one common and shared antenna.

White space transmitter 314 may include sensing capabilities so as to provide a cognitive approach to the transmission of any data. In particular, WS sensor unit 340 may sense whether the white space frequency (which may include one or more TV band frequencies or channels) is available for unlicensed use. In some examples, WS sensor unit 340 may sense whether a white space frequency is available for use by scanning one or more frequencies to determine whether other uses (e.g. licensed users) are already using the white space frequency. However, other techniques for sensing whether a white space frequency is available may also be used. For example, WS sensor unit 340 could also use geo-location sensing to determine the geo-location of the device, and based on the geo-location of the device, available white space may be determined. WS sensor unit 340 may determine white space channels that are empty of any primary users (e.g., using geo-location sensing or spectrum sensing) and may provide this information to the multiplexer (e.g. MUX 112 in FIG. 1).

Channel quality may also be determined by WS sensor unit 340, and could be measured in terms of received signal strength indication (RSSI), interference burstiness, interference duty cycle, estimated interference level (e.g., which may be determined via a filtering technique), type of interference (e.g., the type of signal or device that is causing the interference), or other metrics that reflect channel quality. The multiplexer of the white space device (e.g., MUX 112 in FIG. 1) or other units of the white space device may use the sensed information in a variety of ways. For example, based on the channel quality information determined by WS sensor unit 340, and based on the quality of service (QoS) requirements of the data from input devices, the white space device could match each data stream to the channel with channel quality that is sufficient to satisfy the data stream required QoS. In some cases, the transmitter (e.g., transmitter unit 344) of the white space device may decide to use only a subset of the channels, if the quality of some channels are very bad (as determined by WS sensor unit 340). In some cases, the white space device may avoid interference with specific secondary users discovered on the white space (which could be another remote white space device or a device transmitting a video stream that requests high channel quality). For any channels that have high interference levels but low duty cycle, the white space device may be programmed to send full buffer type of traffic that requires relatively high throughput but has relatively low latency constraints. The white space device may decide to select the transmit power of transmitter unit 344 on specific channels based on the information from WS sensor unit 340.

The sensing by WS sensing unit 340 may occur at periodic intervals sufficient to comply with governmental requirements on the sensing mandated by the government (e.g., the FCC) in order to proceed with unlicensed use of white space frequencies. Information regarding the available channels sensed by WS sensing unit 340 may be provided to transmitter unit 344 so as to facilitate communication of data over such channels. In addition, this information regarding the available channels sensed by WS sensing unit 340 may sometimes be fed back to the white space multiplexer (e.g., MUX 112 of FIG. 1 or MUX 212 of FIG. 2) so as to allow the white space multiplexer to multiplex the different inputs into available white space channels. Accordingly, if available channels change over time, the multiplexing and broadcasting may likewise change so as to ensure that the broadcast signal includes the inputs multiplexed over available channels.

During sensing operations by WS sensing unit 340, TX blanking unit 342 may be used to blank transmitter unit 344 such that transmissions are stopped. During such blanking, non-essential data, such as null data or redundant data may be generated by TX blanking unit 342 so as to ensure that blanking does not undermine the communication of valid data. The blanking of transmitter unit 344 may help to ensure that transmitter unit 344 does not interfere with sensing unit 340 during the sensing intervals. Control unit 346 may generally coordinate transmissions by transmitter unit 344, sensing by WS sensor unit 340, as well as any transmitter blanking invoked by TX blanking unit 342.

The phrase “blanking (or quieting) the transmitter” generally refers to a process in which the transmitter is caused to refrain from transmitting for a period time, although the period of time may vary widely in different implementations. In many cases, the blanking process may include generating non-essential data, such as null data or redundant data by TX blanking unit 342. This way, non-essential data can be fed to transmitter unit 344 over the blanking interval to ensure that valid data is not lost during the blanking interval.

WS senor unit 340 may scan one or more white space channels within a broad spectrum of white space frequency, or may simply search a particular white space channel of interest. In some cases, WS senor unit 340 may scan one or more white space channels, and once WS senor unit 340 identifies an available white space channel, this channel may be used for white space communication by transmitter unit 344. Accordingly, information regarding the available channels sensed by WS sensing unit 340 may be provided to transmitter unit 344 so as to facilitate communication of data over such channels. Furthermore, as mentioned above, information regarding the available channels sensed by WS sensing unit 340 may sometimes be fed back to the white space multiplexer (e.g., MUX 112 of FIG. 1 or MUX 212 of FIG. 2) so as to allow the white space multiplexer to multiplex the different inputs into available white space channels. In this manner, if available channels change over time, the multiplexing and broadcasting may likewise change so as to ensure that the broadcast signal includes the inputs multiplexed over available channels.

In some examples, “white space frequency” may be defined by the “Second Report and Order and Memorandum Opinion and Order” adopted by the Federal Communications Commission (FCC) on Nov. 4, 2008, and released on Nov. 14, 2008 as FCC According to order 08-260, “white space” governed by the United States may comprise unused portions or locations of a broadcast television spectrum that are not currently being used by licensed services, and which therefore may be used by unlicensed radio transmitters. Similar types of white space may exist in other countries, regions, or jurisdictions outside the United States, subject to communication regulatory authorities that may exist in such areas.

In some instances, an available channel of white space may comprise a channel that is currently unoccupied by any users. In addition, an available channel may comprise a channel that is not currently being used by any authorized or licensed users, e.g., users licensed by the FCC. Also, an available channel may comprise a channel that is not currently being used either by licensed users or by unlicensed users, e.g., other white space channel users. In some cases, an available channel may comprise a channel that may be used by a user upon acquiring a secondary license from another licensed user.

For white space sensing by WS sensor unit 340, even after a channel is selected by WS sensor unit 340 for use, subsequent and periodic spectrum sensing may be required in order to verify that usage of the channel does not interfere with usage by other licensed or authorized users. This periodic sensing may be performed by WS sensing unit 340 at the control of control unit 346. During such periodic sensing, control unit 346 may cause TX blanking unit 342 to coordinate blanking of transmitter unit 344 to ensure that transmitter unit 344 does not transmit data during sensing operation. If available channels change over time, WS sensor unit 340 may inform transmitter unit 344 (and possible the white space multiplexer) so that multiplexing and broadcasting can change to ensure that the broadcast signal includes the inputs multiplexed over available channels.

The interval at which periodic sensing should be performed may be specified by applicable rules or regulations. In some cases, the spectrum sensing by WS sensor unit 340 may be required at least once per minute. Transmitter blanking during the spectrum sensing may be desirable because sensing may need to be performed at very low power levels, e.g., to permit detection of lower power signals generated by users of the spectrum, such as licensed users or other authorized users. The FCC order identified above, or other applicable rules or regulations, may require spectrum sensing at specified intervals and at specified power levels to prevent interference with licensed or authorized users of channels in the spectrum. Such spectrum sensing may involve sensing whether other licensed or authorized users are transmitting signals on a given channel or frequency. The lower power signals may be generated by low power transmitters at nearby locations. Alternatively, the lower power signals may be generated by higher power transmitters at remote or nearby locations. However, the signals generated by the higher power transmitters may attenuate over extended distances or suffer fading. In either case, if transmitter unit 344 is enabled during spectrum sensing, transmit power may leak into the spectrum sensing circuitry, creating noise or interference that makes sensing of lower power signals in a spectrum, such as a white space spectrum, more difficult.

WS sensor unit 340 may need to periodically detect for white space channel usage in one or more channels within a white space spectrum, or determine whether any channels that were previously available for use are no longer available (e.g., when a licensed user begins using a particular channel). WS sensor unit 340 may implement a defined duty cycle for spectrum sensing when performing such detection and/or determination functions. Following any sensing operation, one or more available channels can be identified to transmitter unit 344 (and possibly the white space multiplexer). Referring again to FIG. 1, for example, each input to MUX 112 may be multiplexed so as to correspond to an available channel in the white space, MUX 112 may be informed of the available channels by a sensing unit, such as WS sensor unit 340 of FIG. 3.

In some cases, WS sensor unit 340 may receive information about digital TV bands based on the geo-location of the white space device associated with WS transmitter 314. For example, WS sensor unit 340 may maintain a digital TV bands database, which may be organized by geographic location/region or by frequency bands (e.g., low VHF, high VHF, UHF). In such cases, WS sensor unit 340 may also include a geo-location sensor (not shown), which receives or generates geo-location information about the current location of the device.

Also, in some cases, WS sensor unit 340 may maintain a database to indicate channels currently available or in use by WS transmitter 314. The database may also indicate quality levels for different available channels, which may indicate interference levels or signal-to-noise ratios that may be associated with the channels. This database may be accessible to transmitter unit 344 (and possible MUX 112 of FIG. 1 or MUX 212 of FIG. 2) so that multiplexing and broadcasting occurs in a manner that ensures that each of the multiplexed inputs corresponds to at least one available channel. In some cases, each input may require its own available white space channel in the multiplexed signal that is broadcast over white space.

During an initial state, WS sensor unit 340 may scan an initial set of channels in an effort to identify one or more available white space channels available for use by transmitter unit 344. After scanning the initial set of channels, WS sensor unit 340 may assign quality values to the scanned channels. The quality values may be based on signal levels, noise levels, signal to noise levels, received signal strength indication (RSSI), interference (e.g., from extraneous signals or unauthorized/unlicensed users), or other factors. Subsequently, WS sensor unit 340 may scan only a subset of the initial set of channels, wherein each of the subset defines an initial quality value over some threshold. When WS sensor unit 340 defines quality values for channels, transmitter unit 344 (and possible MUX 112 of FIG. 1 or MUX 212 of FIG. 2) may use these quality values to facilitate the multiplexing and broadcasting of the input signals over channels that have the highest quality values.

Again, during sensing operations, TX blanking unit 342 may blank transmitter unit 344. Given this blanking, however, latency may become a concern. Latency greater than 100 milliseconds in video may become noticeable to a human viewer, and therefore, it may be desirable to ensure latency added by blanking transmitter unit 344 does not cause problems, particularly when communicating real-time or live video signals.

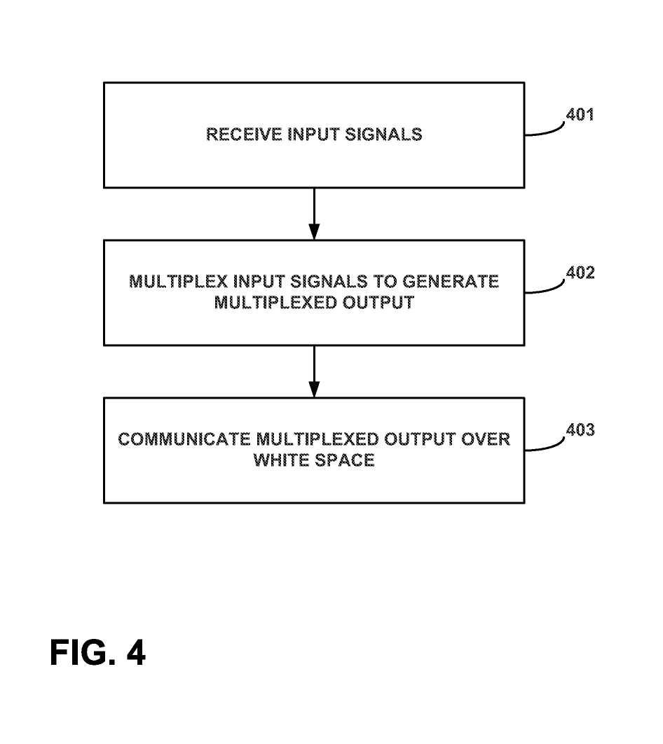

FIG. 4 is a flow diagram illustrating a technique that may be performed by a white space device consistent with this disclosure. FIG. 4 will be described from the perspective of white space device 110 of FIG. 1, although other white space devices may also perform the technique. As shown in FIG. 4, MUX 112 of white space device 110 receives inputs signals (401), such as from external devices coupled to ports (not shown) of white space device 110 or via units within white space device 110 that receive, store or generate the signals. MUX 112 multiplexes the input signals to generate a multiplexed output (402), which may comprise at least two or more of the inputs to MUX 112. White space transmitter 114 then communicates the multiplexed output signal over white space (403), such as via a broadcast signal 150 from antenna 132 of white space transmitter 114 to antenna 134 of white space receiver 122.

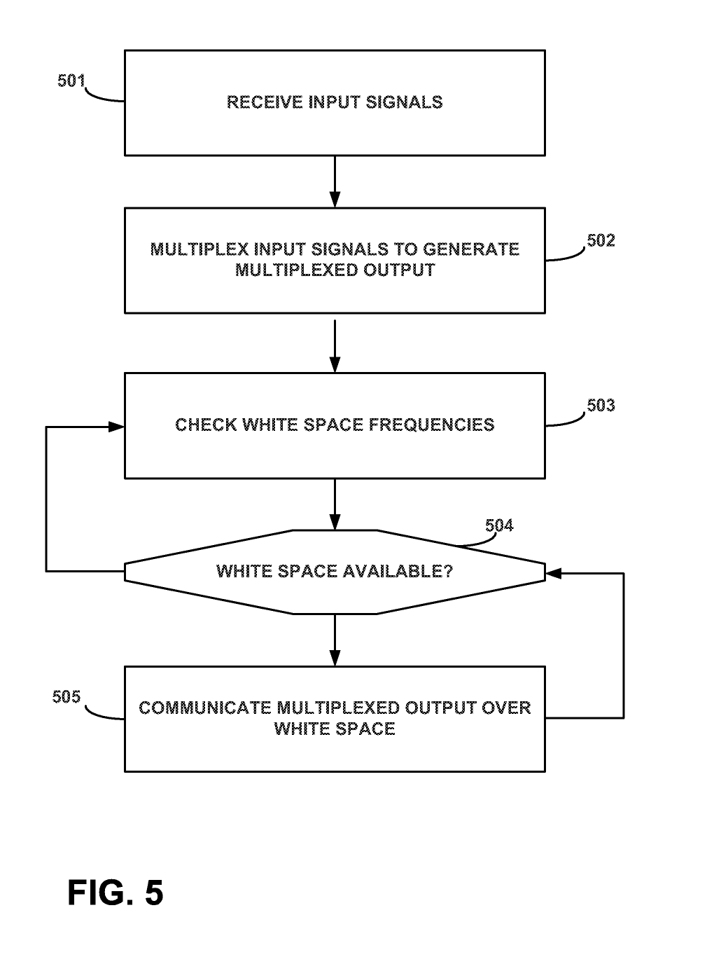

FIG. 5 is another diagram illustrating a technique that may be performed by a white space device consistent with this disclosure. FIG. 5 will also be described from the perspective of white space device 110 of FIG. 1, although other white space devices may perform the technique. As shown in FIG. 5, MUX 112 of white space device 110 receives inputs signals (501), such as from external devices coupled to ports (not shown) of white space device 110 or via units within white space device 110 that receive, store or generate the signals. MUX 112 multiplexes the input signals to generate a multiplexed output (502), which may comprise at least two or more of the inputs to MUX 112.

White space transmitter 114 performs sensing operations to facilitate communication over white space frequencies. In particular, white space transmitter 114 checks white space frequencies (503) for one or more available white space channels. This checking for white space frequencies (503) may include spectrum sensing, geo-location sensing or both. When white space is available (yes, 504), white space transmitter 114 communicates the multiplexed output signal over white space (505), such as via a broadcast signal 150 from antenna 132 of white space transmitter 114 to antenna 134 of white space receiver 122. The white space sensing (503, 504) may be repeated periodically, and broadcast signal 150 may, in some examples, be communicated over a transmit (TX) interval identified during the sensing operations. Typically, some white space channel should be available, such that communications may occur substantially continuously from white space transmitter 114, but the white space channel used may change based on the sensing that is performed. Also, as outlined above, in some cases, the available white space channels identified in the white space sensing (503, 504) may be used by white space transmitter 114 and MUX 112 to facilitate creation of a multiplexed broadcast signal that includes the different inputs multiplexed over available channels at any given time. As the available channels change, the multiplexing and broadcasting may likewise change to ensure that the different inputs of the multiplexed broadcast signal resided in available white space channels. Each input may be multiplexed and communicated in one available channel of the white space frequency.

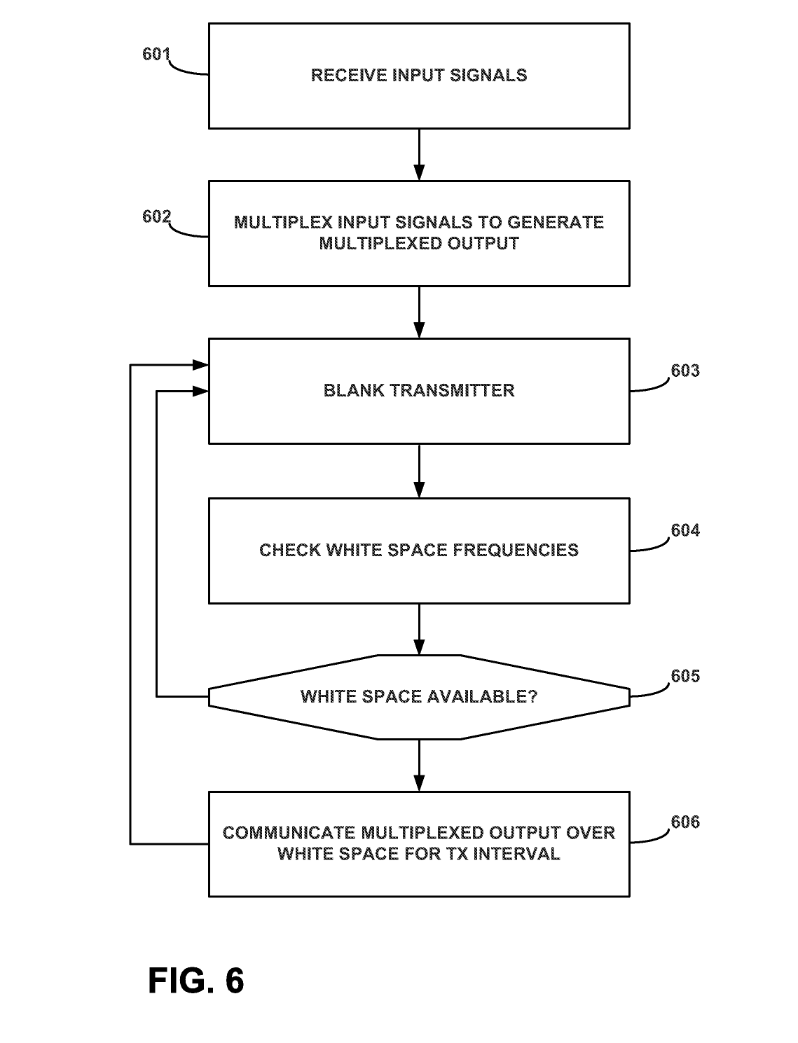

FIG. 6 is another diagram illustrating a technique that may be performed by a white space device consistent with this disclosure. FIG. 6 will also be described from the perspective of white space device 110 of FIG. 1, although other white space devices may perform the technique. As shown in FIG. 6, MUX 112 of white space device 110 receives inputs signals (601), such as from external devices coupled to ports (not shown) of white space device 110 or via units within white space device 110 that receive, store or generate the signals. MUX 112 multiplexes the input signals to generate a multiplexed output (602), which may comprise at least two or more of the inputs to MUX 112.

White space transmitter 114 next performs sensing operations to facilitate communication over white space frequencies, and transmitter blanking is performed during such sensing operations. In particular, white space transmitter 114 blanks (603), and then checks white space frequencies (604) for one or more available white space channels. Referring to FIG. 3, for example, white space transmitter 314 may include a TX blanking unit 342 that blanks transmitter unit 344 as WS sensing unit 340 checks for available channels in white space frequency.

When white space is available (yes, 605), white space transmitter 114 communicates the multiplexed output signal over white space for a transmit (TX) interval (505), such as via a broadcast signal 150 from antenna 132 of white space transmitter 114 to antenna 134 of white space receiver 122. The white space sensing and concurrent transmitter blanking (603, 604, 605) may be repeated periodically. In some cases, multiple white space channels within a white space spectrum may be sensed during one blanking interval. In other cases, separate blanking intervals may be defined for white space channel sensing of different channels within a white space spectrum. Typically some white space channels should be available, such that communications may occur substantially continuously from white space transmitter 114, but the white space channels that are used may change based on the sensing that is performed. The available channels may be stored in a database (possibly with quality metrics assigned to each channel), and the database may be accessible to white space transmitter 114 and MUX 112 to ensure that the white space broadcast signal 150 is properly defined to use the most desirable white space channels for the different inputs at any given time.

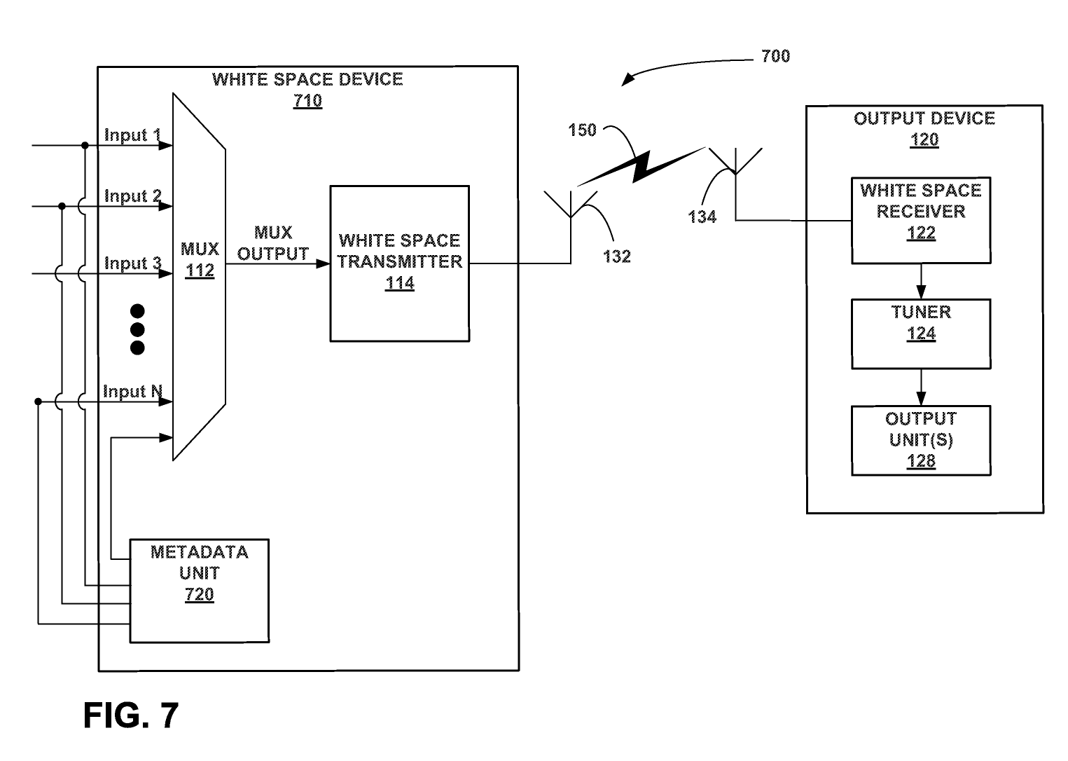

FIG. 7 is another block diagram illustrating a white space device 710 within a system 700 consistent with this disclosure. White space device 710 in FIG. 7 may be very similar to white space device 110 of FIG. 1, in many respects. Indeed, many of the components of system 100 have like-numbered components in system 700. The discussion of these similar components is not repeated, but would operate in the manner described above in the discussion of FIG. 1.

In addition to the components shown in FIG. 1, white space device 710 shown in FIG. 7 also includes a metadata unit 720. Metadata unit 720 receives the same inputs as MUX 112 and generates metadata associated with the inputs. The generated metadata is then sent to MUX 112 for inclusion in the MUX output. The metadata generated by metadata unit 700 may comprise guide information, program information, or any information indicative of the inputs to MUX 112 and/or the data included in the MUX output. In some cases, MUX 112 may communicate with metadata unit 720 to inform metadata unit 720 of the inputs that are included in the MUX output, in which case, metadata unit 720 may generate metadata associated with only those inputs that are actually included in the MUX output.

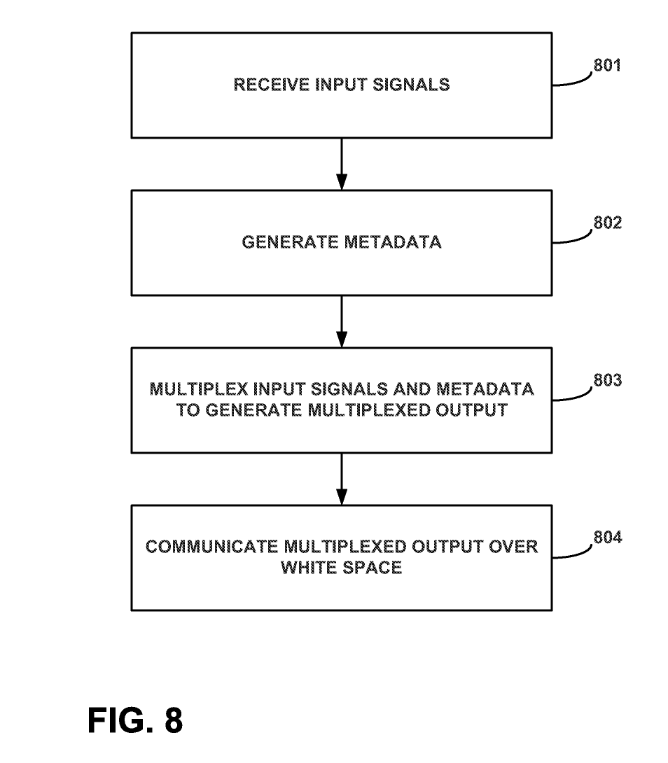

FIG. 8 is a flow diagram illustrating a technique that may be performed by a white space device consistent with this disclosure. FIG. 8 will be described from the perspective of white space device 710 of FIG. 7, although other white space devices may also perform the technique. As shown in FIG. 8, MUX 112 and metadata unit 720 of white space device 710 each receive inputs signals (801), such as from external devices coupled to ports (not shown) of white space device 710 or via units within white space device 710 that receive, store or generate the signals. Metadata unit 720 then generates metadata associated with the inputs (802), which may comprise guide information, program information, or any information indicative of the inputs to MUX 112 and/or the data included in the MUX output.

MUX 112 multiplexes the input signals and the metadata generated by metadata unit 720 to generate a multiplexed output (803), which may comprise at least two or more of the inputs to MUX 112 and metadata associated with these inputs. White space transmitter 114 then communicates the multiplexed output signal over white space (804), such as via a broadcast signal 150 from antenna 132 of white space transmitter 114 to antenna 134 of white space receiver 122. Sensing and transmitter blanking may also be performed as part of this white space communication, as described herein.

The techniques described in this disclosure may be implemented within one or more of a general purpose microprocessor, digital signal processor (DSP), application specific integrated circuit (ASIC), field programmable gate array (FPGA), programmable logic devices (PLDs), or other equivalent logic devices. Accordingly, the terms “processor” or “controller,” as used herein, may refer to any one or more of the foregoing structures or any other structure suitable for implementation of the techniques described herein.

The various components illustrated herein may be realized by any suitable combination of hardware, software, firmware, or any combination thereof. In the figures, various components are depicted as separate units. However, all or several of the various components described with reference to these figures may be integrated into combined units or modules within common hardware, firmware, and/or software. Accordingly, the representation of features as components, units or modules is intended to highlight particular functional features for ease of illustration, and does not necessarily require realization of such features by separate hardware, firmware, or software components. In some cases, various units may be implemented as programmable processes performed by one or more processors.

Any features described herein as modules, devices, or components may be implemented together in an integrated logic device or separately as discrete but interoperable logic devices. In various aspects, such components may be formed at least in part as one or more integrated circuit devices, which may be referred to collectively as an integrated circuit device, such as an integrated circuit chip or chipset. Such circuitry may be provided in a single integrated circuit chip device or in multiple, interoperable integrated circuit chip devices, and may be used in any of a variety of image, display, audio, or other multi-multimedia applications and devices.

If implemented in software, the techniques may be realized at least in part by a non-transitory computer-readable data storage medium comprising code with instructions that, when executed by one or more processors, performs one or more of the methods described above. The computer-readable storage medium may form part of a computer program product, which may include packaging materials. The computer-readable medium may comprise random access memory (RAM) such as synchronous dynamic random access memory (SDRAM), read-only memory (ROM), non-volatile random access memory (NVRAM), electrically erasable programmable read-only memory (EEPROM), embedded dynamic random access memory (eDRAM), static random access memory (SRAM), flash memory, magnetic or optical data storage media. Any software that is utilized may be executed by one or more processors, such as one or more DSP's, general purpose microprocessors, ASIC's, FPGA's, or other equivalent integrated or discrete logic circuitry.

Various aspects have been described in this disclosure. These and other aspects are within the scope of the following claims.

1. A method comprising:
receiving a plurality of input signals at a multiplexer of a white space device;
generating, via the multiplexer, a multiplexed output signal that includes at least two of the plurality of input signals;
sensing whether a white space frequency is available for unlicensed use; and
communicating the multiplexed output signal over the white space frequency via a transmitter of the white space device when the white space frequency is available for unlicensed use.

2. The method of claim 1, wherein the plurality of input signals include one or more multimedia signals and wherein the multiplexed output signal includes at least one of the multimedia signals.

3. The method of claim 1, wherein each of the plurality of input signals comprises a multimedia signal.

4. The method of claim 1, wherein receiving the plurality of input signals comprises receiving the plurality of input signals from different input devices.

5. The method of claim 4, wherein the input devices include one or more of:
a portable multimedia device;
a set top box (STB);
a security camera;
a personal computer (PC); and
a media server.

6. The method of claim 4, further comprising:
communicating the multiplexed output signal over the white space frequency using a forward link; and
communicating reverse-link control signals to at least one of the input devices.

7. The method of claim 1, wherein receiving the plurality of input signals further comprises receiving the plurality of input signals via input ports of the white space device that receive the plurality of input signals from the different input devices and communicate the plurality of input signals to the multiplexer.

8. The method of claim 1, wherein the transmitter comprises a first transmitter, the method further comprising:
communicating the multiplexed output signal via a second transmitter.

9. The method of claim 8, further comprising:
communicating a first portion of the multiplexed output signal via the first transmitter; and
communicating a second portion of the multiplexed output signal via the second transmitter.

10. The method of claim 8, wherein the second transmitter communicates via on or more of:
the Internet; and
a cable network using Quadrature Amplitude Modulation (QAM).

11. The method of claim 1, wherein sensing whether the white space frequency is available for unlicensed use comprises performing sensing operations at periodic intervals.

12. The method of claim 11, wherein sensing whether the white space frequency is available for unlicensed use includes blanking the transmitter during the sensing operations.

13. The method of claim 1, wherein communicating the multiplexed output signal over the white space frequency comprises communicating the multiplexed output signal in a digital broadcast format over the white space frequency.

14. The method of claim 1, wherein the white space frequency comprises one or more frequency bands allocated by a government for unlicensed use.

15. The method of claim 1, wherein the white space frequency includes one or more frequency bands allocated for television by a government for licensed users and allocated for unlicensed use in the absence of use by the licensed users.

16. The method of claim 1, further comprising:
generating metadata associated with the input signals;
generating the multiplexed output signal to include the metadata.

17. An apparatus comprising:
a multiplexer that receives a plurality of input signals and generates a multiplexed output signal that includes at least two of the plurality of input signals; and
a white space transmitter that senses whether a white space frequency is available for unlicensed use, and communicates the multiplexed output signal over the white space frequency when the white space frequency is available for unlicensed use.

18. The apparatus of claim 17, wherein the plurality of input signals include one or more multimedia signals and wherein the multiplexed output signal includes at least one of the multimedia signals.

19. The apparatus of claim 17, wherein each of the plurality of input signals comprises a multimedia signal.

20. The apparatus of claim 17, wherein the apparatus receives the plurality of input signals from different input devices.

21. The apparatus of claim 20, wherein the input devices include one or more of:
a portable multimedia device;
a set top box (STB);
a security camera;
a personal computer (PC); and
a media server.

22. The apparatus of claim 20, wherein the white space transmitter communicates the multiplexed output signal over the white space frequency using a forward link, and another device communicates reverse-link control signals to at least one of the input devices.

23. The apparatus of claim 17, wherein the apparatus includes input ports that receive the plurality of input signals from the different input devices and communicate the plurality of input signals to the multiplexer.

24. The apparatus of claim 17, wherein the white space transmitter comprises a first transmitter, the apparatus further comprises a second transmitter that communicates the multiplexed output signal.

25. The apparatus of claim 24, wherein:
the first transmitter communicates a first portion of the multiplexed output signal, and
the second transmitter communicates a second portion of the multiplexed output signal.

26. The apparatus of claim 24, wherein the second transmitter communicates via on or more of:
the Internet; and
a cable network using Quadrature Amplitude Modulation (QAM).

27. The apparatus of claim 17, wherein in sensing whether the white space frequency is available for unlicensed use, the white space transmitter senses performs sensing operations at periodic intervals.

28. The apparatus of claim 27, wherein in sensing whether the white space frequency is available for unlicensed use, the white space transmitter blanks during the sensing operations.

29. The apparatus of claim 17, wherein in communicating the multiplexed output signal over the white space frequency, the white space transmitter communicates the multiplexed output signal in a digital broadcast format over the white space frequency.

30. The apparatus of claim 17, wherein the white space frequency comprises one or more frequency bands allocated by a government for unlicensed use.

31. The apparatus of claim 17, wherein the white space frequency includes one or more frequency bands allocated for television by a government for licensed users and allocated for unlicensed use in the absence of use by the licensed users.

32. The apparatus of claim 17, further comprising a metadata unit that receives the input signals and generates metadata associated with the input signals, wherein the multiplexer generates the multiplexed output signal to include the metadata.

33. The apparatus of claim 17, wherein the apparatus comprises at least one of:
an integrated circuit;
a microprocessor,
a wireless broadcast device.

34. A device comprising:
means for receiving a plurality of input signals in a white space device;
means for generating a multiplexed output signal that includes at least two of the plurality of input signals;
means for sensing whether a white space frequency is available for unlicensed use; and
means for communicating the multiplexed output signal over the white space frequency when the white space frequency is available for unlicensed use.

35. The device of claim 34, wherein the plurality of input signals include one or more multimedia signals and wherein the multiplexed output signal includes at least one of the multimedia signals.

36. The device of claim 34, wherein the means for receiving comprise input ports of the device that receive the plurality of input signals from the different input devices.

37. The device of claim 34, wherein the means for sensing whether the white space frequency is available for unlicensed use comprises means for performing sensing operations at periodic intervals.

38. The device of claim 37, wherein the means for sensing whether the white space frequency is available for unlicensed use includes means for blanking communication during the sensing operations.

39. The device of claim 34, further comprising:
means for generating metadata associated with the input signals, wherein the means for generating the multiplexed output signal generates the multiplexed output signal to include the metadata.

40. A computer-readable storage medium comprising instructions that upon execution cause one or more processor to:
upon receiving a plurality of input signals at a multiplexer of a white space device,
generate, via the multiplexer, a multiplexed output signal that includes at least two of the plurality of input signals;
sense whether a white space frequency is available for unlicensed use; and
communicate the multiplexed output signal over the white space frequency via a transmitter of the white space device when the white space frequency is available for unlicensed use.

41. The computer-readable storage medium of claim 40, wherein the plurality of input signals include one or more multimedia signals and wherein the multiplexed output signal includes at least one of the multimedia signals.

42. The computer-readable storage medium of claim 40, wherein in sensing whether the white space frequency is available for unlicensed use, the instructions cause the one or more processor to perform sensing operations at periodic intervals.

43. The computer-readable storage medium of claim 42, wherein in sensing whether the white space frequency is available for unlicensed use, the instructions cause the one or more processor to blank the transmitter during the sensing operations.

44. The computer-readable storage medium of claim 40, wherein the instructions cause the one or more processor to:
generate metadata associated with the input signals;
generate the multiplexed output signal to include the metadata.
